(19) United States
(12) Patent Application Publication
(10) Pub. No.: US 2006/0250084 A1
(43) Pub. Date: Nov. 9, 2006

(54) OLED device with improved light output

(75) Inventors: Ronald S. Cok, Rochester, NY (US); Joel D. Shore, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/122,295

(22) Filed: May 4, 2005

(51) Int. Cl. H05B 33/14; H01J 1/62

(52) U.S. Cl. 313/512; 313/504

(57) ABSTRACT

An organic light-emitting diode (OLED) device is described, comprising: a) a substrate; b) an OLED formed over the substrate comprising a first electrode, a partially transparent second electrode through which light from the OLED is emitted, and at least one layer of organic light-emitting material disposed between the first electrode and partially transparent second electrode; and c) an encapsulating layer deposited on the partially transparent second electrode, wherein the encapsulating layer comprises one or more component layers, and wherein the encapsulating layer and the partially transparent second electrode combined have a transparency greater than the transparency of the partially transparent second electrode in the absence of the encapsulating layer, or wherein the encapsulating layer and the partially transparent second electrode combined have an absorbance less than the absorbance of the partially transparent second electrode in the absence of the encapsulating layer. To provide adequate encapsulation, in accordance with various embodiments of the invention at least one component layer of the encapsulating layer is deposited by atomic layer deposition, or the total thickness of encapsulating layer is at least about 150 nm. In a preferred embodiment, both such features are incorporated.

### FIELD OF THE INVENTION

The present invention relates to organic light-emitting diode (OLED) devices and, more particularly, to a method of making an OLED device having improved light output and power distribution through a light-transmissive electrode.

### BACKGROUND OF THE INVENTION

Organic light-emitting diode (OLED) devices, also referred to as organic electroluminescent (EL) devices, have numerous well-known advantages over other flat-panel display devices currently in the marketplace. Among the potential advantages are brightness of light emission, relatively wide viewing angle, reduced device thickness, and reduced electrical power consumption compared to, for example, liquid crystal displays (LCDs) using backlighting.

Applications of OLED devices include active-matrix image displays, passive-matrix image displays, and area-lighting devices such as, for example, selective desktop lighting. Irrespective of the particular OLED device configuration tailored to these broad fields of applications, all OLEDs function on the same general principles. An organic electroluminescent (EL) medium structure is sandwiched between two electrodes. At least one of the electrodes is at least partially light transmissive. These electrodes are commonly referred to as an anode and a cathode in analogy to the terminals of a conventional diode. When an electrical potential is applied between the electrodes so that the anode is connected to the positive terminal of a voltage source and the cathode is connected to the negative terminal, the OLED is said to be forward-biased. Positive charge carriers (holes) are injected from the anode into the EL medium structure, and negative charge carriers (electrons) are injected from the cathode. Such charge carrier injection causes current flow from the electrodes through the EL medium structure. Recombination of holes and electrons within a zone of the EL medium structure results in emission of light from this zone that is, appropriately, called the light-emitting zone or interface. The organic EL medium structure can be formed of a stack of sublayers that can include small molecule layers and polymer layers. Such organic layers and sublayers are well known and understood by those skilled in the OLED art. Depending on the nature of the organic EL medium, the device may emit a variety of colors of light or a broad band, substantially white, light.

The emitted light is directed towards an observer, or towards an object to be illuminated, through the light transmissive electrode. If the light transmissive electrode is between the substrate and the light emissive elements of the OLED device, the device is called a bottom-emitting OLED device. Conversely, if the light transmissive electrode is not between the substrate and the light emissive elements, the device is referred to as a top-emitting OLED device.

In top-emitting OLED devices, light is emitted through an upper electrode or top electrode, typically but not necessarily the cathode, which has to be sufficiently light transmissive, while the lower electrode(s) or bottom electrode(s), typically but not necessarily the anode, can be made of relatively thick and electrically conductive metal compositions which can be optically opaque. Because light is emitted through an electrode, it is important that the electrode through which light is emitted be sufficiently light transmissive to avoid absorbing the emitted light. Typical prior-art materials used for such electrodes include indium tin oxide (ITO) and very thin layers of metal, for example silver or metal alloys including silver. However, the current carrying capacity of such electrodes is limited, thereby limiting the amount of light that can be emitted from the organic layers. Moreover, metallic layers may create unwanted cavity effects.

Organic light-emitting diode (OLED) display devices typically require humidity levels below about 1000 parts per million (ppm) to prevent premature degradation of device performance within a specified operating and/or storage life of the device. Control of the environment to this range of humidity levels within a packaged device is typically achieved by encapsulating the device with an encapsulating layer and/or by sealing the device and a desiccant within a cover. Desiccants such as, for example, metal oxides, alkaline earth metal oxides, sulfates, metal halides, and perchlorates are used to maintain the humidity level below the above level. See for example U.S. Pat. No. 6,226,890 B1 issued May 8, 2001 to Boroson et al. describing desiccant materials for moisture-sensitive electronic devices. Such desiccating materials are typically located around the periphery of an OLED device or over the OLED device itself.

In alternative approaches, an OLED device is encapsulated using thin multi-layer coatings of moisture-resistant material. For example, layers of inorganic materials such as metals or metal oxides separated by layers of an organic polymer may be used. Such coatings have been described in, for example, U.S. Pat. Nos. 6,268,695, 6,413,645 and 6,522,067. A deposition apparatus is further described in WO2003090260 A2 entitled “Apparatus for Depositing a Multilayer Coating on Discrete Sheets”. WO0182390 entitled “Thin-Film Encapsulation of Organic Light-Emitting Diode Devices” describes the use of first and second thin-film encapsulation layers made of different materials wherein one of the thin-film layers is deposited at 50 nm using atomic layer deposition (ALD) discussed below. According to this disclosure, a separate protective layer is also employed, e.g. parylene and/or SiO₂. Such thin multi-layer coatings typically attempt to provide a moisture permeation rate of less than 5×10⁻⁶ gm/m²/day to adequately protect the OLED materials. In contrast, typically polymeric materials have a moisture permeation rate of approximately 0.1 gm/m²/day and cannot adequately protect the OLED materials without additional moisture blocking layers. With the addition of inorganic moisture blocking layers, 0.01 gm/m²/day may be achieved and it has been reported that the use of relatively thick polymer smoothing layers with inorganic layers may provide the needed protection. Thick inorganic layers, for example 5 microns or more of ITO or ZnSe, applied by conventional deposition techniques such as sputtering or vacuum evaporation may also provide adequate protection, but thinner conventionally coated layers may only provide protection of 0.01 gm/m²/day.

WO2004105149 A1 entitled “Barrier Films for Plastic Substrates Fabricated by Atomic Layer Deposition” published Dec. 2, 2004 describes gas permeation barriers that can be deposited on plastic or glass substrates by atomic layer deposition (ALD). Atomic Layer Deposition is also known as Atomic Layer Epitaxy (ALE) or atomic layer CVD (ALCVD), and reference to ALD herein is intended to refer to all such equivalent processes. The use of the ALD coatings can reduce permeation by many orders of magnitude at thicknesses of tens of nanometers with low concentrations of coating defects. These thin coatings preserve the flexibility and transparency of the plastic substrate. Such articles are useful in container, electrical, and electronic applications. However, as taught in the prior art, such coatings might not be sufficiently conductive or transparent to provide or enable a transparent, conductive electrode.

Referring to FIG. 2, a top-emitting OLED device as proposed in the prior art is illustrated having a substrate 10 (either reflective, transparent, or opaque), a patterned reflective first electrode 12 defining pixels 30, 32, 34, 36, 38, one or more layers 14 of organic material, at least one of which is light-emitting, a transparent second electrode 17, a gap 19 and an encapsulating cover 20. The encapsulating cover 20 is transparent and may be coated as a layer directly over the transparent electrode 17 so that no gap 19 exists. In this case, a protective cover is typically provided. It has been proposed to fill the gap with polymeric or desiccating material. Such polymers and desiccants typically will have indices of refraction greater than or equal to that of the substrate 10 or encapsulating cover 20, and it is generally proposed to employ materials having indices of refraction roughly matched to that of the encapsulating cover to reduce interlayer reflections. Light 1 emitted from one of the organic material layers 14 can be emitted directly out of the device, through the encapsulating cover 20. In some prior-art embodiments, the first electrode 12 may instead be at least partially transparent and/or light absorbing. It is known that much of the emitted light may be trapped in the OLED layers 14, electrodes 12 and/or 17, and cover 20 or substrate 10, thereby reducing the efficiency of the OLED device. Desiccating material 26 may be located at the periphery of the OLED device. However, this increases the area of the substrate and cover and is not completely effective. Alternatively, desiccating material may be located over the OLED device, for example on electrode 17. This approach is less practical for top-emitters, since the desiccants, in that case, need to be highly transparent and uniformly distributed. Multi-layer encapsulating coatings deposited directly on electrode 17 may be more effective, but have not been taught for increasing the light-output efficiency of an OLED device or for addressing the difficulty of providing a sufficiently transparent top electrode with adequate conductivity.

Applicants have demonstrated that in order to supply adequate uniform current to an OLED while permitting adequate amounts of light to escape from the device without employing additional electrode bussing, the sheet resistance of a transparent electrode suitable for use in a prior-art top-emitter OLED device configuration such as FIG. 2 should be less than 3.2 ohms per square, more preferably less than 2.0 ohms per square, and most preferably less than 1.0 ohm per square, while also preferably providing a transparency of at least 50%, more preferably at least 70%. For large OLED devices (greater than 5 inches in diagonal), the preferred resistance requirements are lower still. While highly light-transmissive electrode materials such as ITO have been proposed for top-emitting devices, ITO does not provide as high a conductivity as may be desired.

The use of sufficiently thin metal layers providing at least partial transparency may alternatively be employed to provide adequate conductivity. For instance, microcavity structures employing a highly reflective bottom electrode and a partially reflective, semi-transparent continuous top electrode have been proposed as a means for increasing the light output from the OLED device. By carefully tuning the thickness of the layers between these two electrodes, an appropriate color of light with increased brightness can be emitted from the OLED, even with the metal upper electrode. Applicants have demonstrated good results with a 20 nm thick layer of silver as an upper electrode and an aluminum or silver bottom anode. 20 nm of silver may have a sheet resistance of 0.80 ohms per square. Such microcavity designs are known in the art, see for example US 2004/0140757 and 2004/0155576. US 2005/0073228 describes a white-light emitting OLED apparatus comprising a microcavity OLED device and a light-integrating element, wherein the microcavity OLED device has a white light emitting organic EL element and the microcavity OLED device is configured to have angular-dependent narrow-band emission, and the light-integrating element integrates the angular-dependent narrow-band emission from different angles from the microcavity OLED device to form white light emission. However, such microcavity designs require very precise control of layer thicknesses in order to obtain the desired color, and may also create a strong angular dependence on the color of light emitted, especially if broadband emitters are employed. Further, it is still difficult to achieve a desired combination of high transparency and high conductivity, as such semitransparent structures typically do not transmit all of the light created in the OLED.

As described for example in Tyan et al., U.S. Pat. No. 6,861,800 and US20050037232 A1, it has also been proposed to employ an absorption-reduction layer (ARL) in association with the partially reflective electrode employed in a microcavity device to inhibit absorption of light that passes through it. By carefully controlling the relative thicknesses of the partially reflective electrode and absorption-reduction layer, the absorption of an electrode, in particular a highly conductive metal electrode, such as silver, may be reduced. Such absorption-reduction layers typically have a thickness on the order of, or less than, a wavelength of the light transmitted. Applicants have demonstrated an effective 60 nm-thick absorption-reduction layer comprising ITO in combination with a silver electrode. Riel et al. [Applied Physics Letters 82, 466 (2003) and Journal of Applied Physics 94, 5290 (2003)] describe top-emitting organic light-emitting devices with improved light outcoupling by means of a dielectric capping layer deposited over a thin metal cathode, with optimized light outcoupling efficiency obtained with a 60 nm ZnSe capping layer. However, these absorption-reduction layers and dielectric layers cannot be used with an additional encapsulating layer because the optical characteristics of the structure are changed when the additional encapsulating layers are included and the absorption reduction effect is diminished or destroyed. Moreover, prior art proposed ARL layers would typically not provide adequate desired encapsulation in view of the thickness and means of deposition typically employed.

In an alternative approach to overcoming the problem of inadequate transparent and conductive electrode materials, an electrode bussing scheme may be considered. Referring to FIG. 2 again, in such an arrangement, electrode busses 41 for the transparent electrode 17 are formed over the OLED device substrate 10 and vias 40 are created through the organic layers 14. When the transparent electrode 17 is deposited over the organic layers 14, it will also be deposited over the vias 40 to connect the transparent electrode 17 to the electrode bus 41. Electrode busses 41 may be separated from electrode 12 with insulator 42. Most of the current distribution is then conducted through the electrode busses 41 and a relatively less conductive and more transparent electrode 17 may be employed over the organic layers 14, for example ITO. Such an approach is described in US 2004/0253756. Other related designs employ auxiliary electrodes to distribute power to a top electrode. For example, U.S. Patent Application Publication 2002/0011783 A1, U.S. Patent Application Publication 2001/0043046 A1, and U.S. Patent Application Publication 2002/0158835 A1 describe the use of auxiliary conductive elements electrically connected to the top electrode. However, these approaches all have the disadvantage of requiring that additional patterning steps be employed to form vias or to otherwise pattern the top electrode. Moreover, they do not increase the optical efficiency of the OLED device as a microcavity does.

Scattering techniques are also known to improve light output from an OLED device. Chou (International Publication Number WO 02/37580 A1) and Liu et al. (U.S. Patent Application Publication No. 2001/0026124 A1) taught the use of a volume or surface scattering layer to improve light extraction. The scattering layer is applied next to the organic layers or on the outside surface of the glass substrate or cover and has an optical index that matches these layers. Light emitted from the OLED device at higher than critical angle that would have otherwise been trapped can penetrate into the scattering layer and be scattered out of the device.

Light-scattering layers used externally to an OLED device are described in U.S. Patent Application Publication No. 2005/0018431 entitled “Organic electroluminescent devices having improved light extraction” by Shiang and U.S. Pat. No. 5,955,837 entitled “System with an active layer of a medium having light-scattering properties for flat-panel display devices” by Horikx, et al. These disclosures describe and define properties of scattering layers located on a substrate in detail. Likewise, U.S. Pat. No. 6,777,871 entitled “Organic ElectroLuminescent Devices with Enhanced Light Extraction” by Duggal et al. describes the use of an output coupler comprising a composite layer having specific refractive indices and scattering properties. The use of light scattering techniques may increase the light-output efficiency of an OLED device but does not address the difficulty of providing a sufficiently transparent top electrode with adequate conductivity.

There is a need therefore for an improved organic light-emitting diode device structure that increases the light output, provides improved conductivity of the transparent electrode without a burdensome manufacturing process, and provides desired encapsulation.

### SUMMARY OF THE INVENTION

In accordance with one embodiment, the invention is directed towards an organic light-emitting diode (OLED) device, comprising:

a) a substrate;

b) an OLED formed over the substrate comprising a first electrode, a partially transparent second electrode through which light from the OLED is emitted, and at least one layer of organic light-emitting material disposed between the first electrode and partially transparent second electrode; and

c) an encapsulating layer deposited on the partially transparent second electrode, wherein the encapsulating layer comprises one or more component layers deposited by atomic layer deposition, wherein the encapsulating layer and the partially transparent second electrode combined have a transparency greater than the transparency of the partially transparent second electrode in the absence of the encapsulating layer, or wherein the encapsulating layer and the partially transparent second electrode combined have an absorbance less than the absorbance of the partially transparent second electrode in the absence of the encapsulating layer.

In accordance with a second embodiment, the invention is directed towards an organic light-emitting diode (OLED) device, comprising:

a) a substrate;

b) an OLED formed over the substrate comprising a first electrode, a partially transparent second electrode through which light from the OLED is emitted, and at least one layer of organic light-emitting material disposed between the first electrode and partially transparent second electrode; and

c) an encapsulating layer deposited on the partially transparent second electrode, wherein the encapsulating layer comprises one or more component layers having a total thickness of at least 150 nm, and wherein the encapsulating layer and the partially transparent second electrode combined have a transparency greater than the transparency of the partially transparent second electrode in the absence of the encapsulating layer, or wherein the encapsulating layer and the partially transparent second electrode combined have an absorbance less than the absorbance of the partially transparent second electrode in the absence of the encapsulating layer.

### ADVANTAGES

Various embodiments of the present invention have the advantages that by employing an encapsulating layer specifically designed to increase transparency and/or decrease light absorbance in an adjacent electrode, light output from an OLED device may be increased. Various embodiments further enable improved conductivity of a transparent electrode, improved OLED device encapsulation, and reduced manufacturing cost of an OLED device. In some embodiments, the present invention may also reduce or eliminate the color dependence on angle of emission for devices employing a semi-transparent electrode.

### BRIEF DESCRIPTION OF THE DRAWINGS

FIG. 1 illustrates a cross section of a top-emitter OLED device according to one embodiment of the present invention;

FIG. 2 illustrates a cross section of a prior-art top-emitter OLED device;

FIG. 3 is a graph illustrating the conductivity and transparency of various materials useful for a transparent electrode of an OLED device;

FIG. 4 illustrates a cross section of a top-emitter OLED device according to another embodiment of the present invention;

FIG. 5 illustrates a cross section of a top-emitter OLED device according to yet another embodiment of the present invention;

FIG. 6 illustrates a cross section of a top-emitter OLED device according to yet another embodiment of the present invention;

FIG. 7 illustrates a cross section of a top-emitter OLED device according to yet another embodiment of the present invention;

FIG. 8 illustrates a cross section of a top-emitter OLED device according to an alternative embodiment of the present invention; and

FIGS. 9a, 9b, and 9c illustrate the overall light output, on-axis transmittance, and on-axis absorption for various thicknesses of an ARL in various embodiments of the present invention.

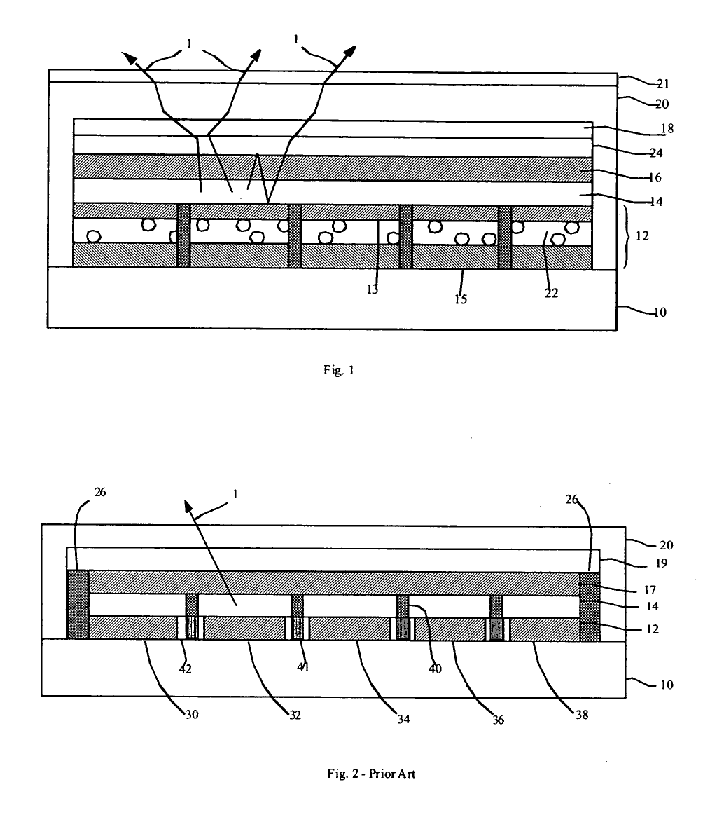

It will be understood that the figures are not to scale since the individual layers are too thin and the thickness differences of various layers too great to permit depiction to scale.

### DETAILED DESCRIPTION OF THE INVENTION

Referring to FIG. 1, in accordance with one embodiment of the present invention, an organic light-emitting diode (OLED) device comprises a substrate 10; an OLED formed over the substrate 10 comprising a first electrode 12, a partially transparent second electrode 16 through which light from the OLED is emitted, and at least one layer 14 of organic light-emitting material disposed between the first electrode 12 and the partially transparent second electrode 16; an encapsulating layer 24 comprises one or more component layers deposited on the partially transparent second electrode 16, wherein the encapsulating layer 24 and the partially transparent second electrode 16 combined have a transparency greater than the transparency of the partially transparent second electrode 16 in the absence of the encapsulating layer 24, or wherein the encapsulating layer 24 and the partially transparent second electrode 16 combined have an absorbance less than the absorbance of the partially transparent second electrode 16 in the absence of the encapsulating layer 24. Also shown in FIG. 1 are an optional protective cover 20 and optional anti-reflection layer 21.

As employed herein, an encapsulating layer is any layer coated over the partially transparent electrode 16 that reduces the permeation of oxygen and moisture into and through the partially transparent electrode 16. Such layers can include thick (e.g. greater than 5 microns) inorganic coatings, layers of inorganic materials such as metals or metal oxides separated by layers of an organic polymer, relatively thick polymer smoothing layers with inorganic layers, and layers of inorganic materials deposited by atomic layer deposition. However, according to the present invention, the encapsulating layer must also provide an improvement in transparency or reduction in absorption of the partially transparent electrode. To provide adequate encapsulation, in accordance with various embodiments of the invention it is a requirement that at least one component layer of encapsulating layer 24 be deposited by atomic layer deposition, or that the total thickness of encapsulating layer 24 be at least about 150 nm. In a preferred embodiment, both such features are incorporated.

An optional light scattering layer 22 may be employed between the substrate 10 and cover 20 for scattering light emitted by the light-emitting layer 14 and reflected by the first electrode 12 and partially transparent second electrode 16. To avoid potentially compromising the increased transparency or reduced absorbance of the combined partially transparent second electrode 16 and encapsulating layer 24, light scattering layer 22 when employed preferably should be positioned between the substrate and the second electrode 16. The first electrode 12 may comprise multiple layers, for example a transparent conductive layer 13, a scattering layer 22, and a reflective layer 15. The reflective layer 15 is preferably made of a metal with high reflectivity such as silver, aluminum, or magnesium silver. The first electrode 12 may be pixellated to form distinct light emitting areas. The partially transparent second electrode 16 may also be patterned or it may be a continuous, unpatterned layer (as shown). The partially transparent electrode 16 preferably has a transparency of at least 20%, more preferably at least 50%, and most preferably at least 70% at 550 nm. In a particular embodiment, the partially transparent electrode may have a transparency of from 20% to 90% at 550 nm. As employed herein, a light scattering layer is an optical layer that tends to randomly redirect any light that impinges on the layer from any direction. The organic material layers 14 may comprise organic materials known in the art, for example, hole-injection, hole-transport, light-emitting, electron-injection, and/or electron-transport layers. Such organic material layers are well known in the OLED art. The first electrode 12 may be a reflective electrode to enable light emission from one side of the OLED device.

A transparent low-index element layer 18 (possibly an air gap) having a refractive index lower than the refractive index of the cover 20, the encapsulating layer 24, and the organic layers 14 (and most preferably as low, or nearly as low, as the refractive index of air) may be located between the encapsulating layer 24 and the cover 20. The use of such a transparent low-index layer 18 to enhance the sharpness of an OLED device having a scattering layer is described in co-pending, commonly assigned U.S. Ser. No. 11/065,082 filed Feb. 24, 2005 (Docket 89211), the disclosure of which is hereby incorporated in its entirety by reference, and may be employed in concert with the present invention.

To provide increased electrical conductivity, partially transparent electrode 16 is preferably made of metal or metal alloys, for example aluminum, silver, or magnesium silver, and may incorporate other dopants and/or layers such as lithium, molybdenum, or oxides to enhance the conductivity or electron-injection capabilities of the partially transparent electrode 16. The partially transparent electrode 16 may have a thickness greater than 5 nanometers to improve current-carrying capability (for example a thickness of 10 nm, 20 nm, or more) or less than 5 nm to provide improved transparency. The partially transparent electrode 16 preferably has a sheet resistance of less than 3.20 ohms per square. In a preferred embodiment, partially transparent second electrode 16 comprises silver. The use of a metal to enhance the conductivity of a partially transparent second electrode 16 in combination with a scattering layer is described in co-pending, commonly assigned U.S. Ser. No. 11/106,277 filed Apr. 14, 2005 (Docket 89736), the disclosure of which is hereby incorporated in its entirety by reference, and may be employed in concert with the present invention.

According to an embodiment of the present invention, the partially transparent second electrode 16 is unpatterned, and the OLED device need not include, for example, a grid pattern of thick conductors either formed directly on the partially transparent second electrode 16 or connected to it. Likewise, in this embodiment, the partially transparent second electrode 16 need not employ vias to electrode busses to provide additional current distribution in an OLED device. Such patterned elements require additional manufacturing process steps that raise the cost of such OLED devices. Alternatively, patterned elements such as grid conductors and vias with busses may be employed in concert with the present invention to further improve the conductivity of the partially transparent second electrode 16. The partially transparent second electrode 16 is preferably deposited directly over the organic layers 14 in a single continuous deposition step, for example by sputtering, and does not require masking within the light-emitting area of the OLED device.

The encapsulating layer 24 formed adjacent to the partially transparent second electrode 16 may be formed of a variety of materials, such as metal oxides deposited in thin layers. In one embodiment of the present invention, the encapsulating layer 24 formed adjacent to the partially transparent second electrode 16 comprises at least one component layer formed by atomic layer deposition. For example, applicants have demonstrated an atomic layer deposition process whereby trimethylaluminum is first deposited over the partially transparent electrode 16 using chemical vapor deposition followed by exposure to oxygen in the form of ozone. The aluminum and oxygen combine to form a very thin layer of Al₂O₃. The process may then be repeated until a plurality of layers comprising a suitable thickness is achieved. Such a multi-layer is highly transparent and provides a thin-film (for example less than 5 microns thick) encapsulating layer with very low permeation rates (for example on the order of 10⁻⁶ gm/m²/day). Subject to providing desired optical and encapsulation properties, the thin-film encapsulating layer may be less than 1 micron thick and preferably less than 500 nm and more preferably less than 270 nm. Other materials and processes may also be employed, for example as described in the “Handbook of Thin Film Process Technology” published by the Institute of Physics Publishing, 1995, edited by Glocker and Shah or as described in the “Handbook of Thin Film Materials” published by the Academic Press, Harcourt, Inc. 2002, edited by Nalwa (vol. 1, chapter 2 “Atomic Layer Deposition” by Ritala and Leskala).

Useful thin film encapsulating layer materials which may be deposited by atomic layer deposition can include Zn, ZnSe, ZnS₁₋ₓSeₓ, ZnTe, CaS, SrS, BaS, SrS₁₋ₓSeₓ, CdS, CdTe, MnTe, HgTe, Hg₁₋ₓCdₓTe, Cd₁₋ₓMnₓTe, AlN, GaN, InN, SiNₓ, Ta₃N₅, TiN, TiSiN, TaN, NbN, MoN, W₂N, Al₂O₃, TiO₂, ZrO₂, HfO₂, Ta₂O₅, Nb₂O₅, Y₂O₃, MgO, CeO₂, SiO₂, La₂O, SrTiO₃, BaTiO₃, BiₓTi_{y}, O_{z}, Indium Tin Oxide, Indium Oxide, SnO₂, NiO, CO₃O₄, MnOx, LaCoO₃, LaNiO₃, LaMnO3, CaF₂, SrF₂, ZnF₂, Si, Ge, Cu, Mo, Ta, W, La₂S₃, PbS, In₂S₃, CuGaS₂, and SiC (x, y, and z positive integers).

Encapsulating layers according to another embodiment of the present invention may include alternating organic and inorganic layers, for example of polymer and ceramic films, such as those sold under the Barix trade name by Vitex Systems, Inc.

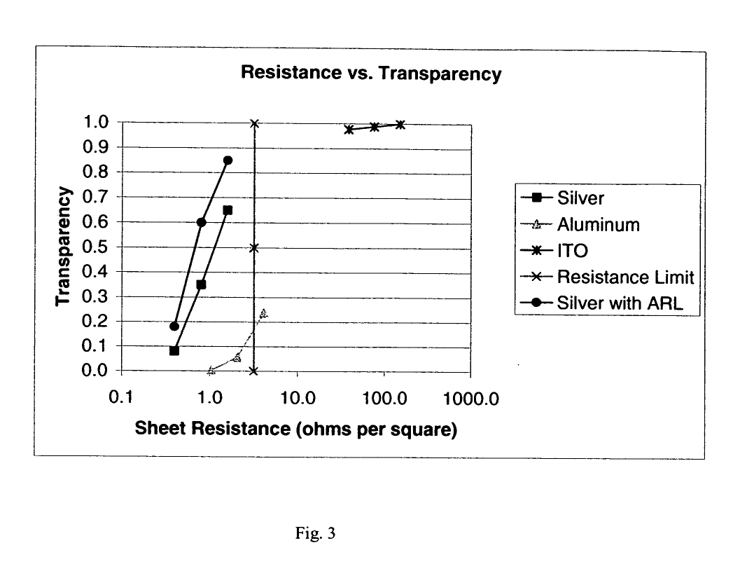

In FIG. 3, the transparency and sheet resistance of a variety of electrically conductive materials coated at 10 nm, 20 nm, and 40 nm are shown. For each material, the thinner coatings are more transparent but have lower conductivity (higher sheet resistance). The thicker coatings are less transparent but have higher conductivity (lower sheet resistance). While highly transparent, ITO has lower than desired conductivity. Silver, a highly conductive metal, when coated at thickness required to provide the preferred conductivity is less than 50% transparent. Aluminum is both less conductive and less transmissive than silver. As also illustrated in FIG. 3, to improve transparency, a partially reflective semi-transparent metal layer electrode may be used in combination with an absorption-reduction layer (ARL), as described for example in Tyan et al., U.S. Pat. No. 6,861,800, to inhibit absorption of light that passes through it. By carefully controlling the relative thicknesses of the partially reflective semi-transparent electrode and absorption-reduction layer, the absorption of the semi-transparent electrode, in particular a highly conductive metal electrode such as silver, may be reduced. By specifically selecting encapsulating layer materials and thickness to achieve increased light output through a partially transparent electrode, the present invention advantageously combines these features.

Whether formed by a single layer or multiple component layers, the total thickness of the encapsulating layers is carefully chosen to provide adequate encapsulation and to optically combine with the partially transparent second electrode 16 to provide a transparency greater than the transparency of partially transparent second electrode 16 alone or to provide an absorption less than the absorption of partially transparent second electrode 16 alone. Those skilled in the art will recognize that the combined structure consisting of the partially transparent electrode and encapsulating layers can absorb, transmit, and reflect light. In general, absorption of light by this structure will have an unambiguously negative effect. Reflection of light will generally have a somewhat less negative effect since it leaves open the possibility that the reflected light will be redirected and eventually emitted from the device. In fact, in the case of a microcavity structure, the light output of the device is actually maximized for a nonzero value of the reflectance, with values of the reflectance that are greater or lesser than this optimal value yielding less light output. Thus, it is difficult to state a single criterion in terms of absorbance, transmittance, or reflectance alone that will optimize the light output of the device for any conceivable device. Hence, an improvement in transparency or a reduction in absorption may increase the amount of light emitted from the OLED device of the present invention.

Using the criterion of minimizing the absorption, the desired thickness of the encapsulating layers can be described approximately as tλ/4n where t is an odd positive integer, n is the refractive index of the encapsulating layer, and λ is the wavelength of any emitted light. The wavelength λ is typically in the visible range, for example from 400 nm to 700 nm. Hence, there is a range of acceptable thicknesses depending on the wavelength, the value of n, and the value of t. The absorption-reduction layer operates by reflecting some emitted light from the surface opposite the surface in contact with the conductive partially transparent second electrode 16 so that the reflected light travels approximately one half wavelength before arriving back in the conductive partially transparent second electrode 16. The electric field due to this back-traveling light then partially cancels the electric field due to the forward-traveling light in the partially transparent second electrode 16. The reduction in electric field reduces the optical absorption of the partially transparent second electrode 16. Any odd multiple of the total distance may be employed to provide destructive interference, for example λ/2 n, 3λ/2 n, etc. so that the thickness of the encapsulation layer 24 is one half the total distance or λ/4 n, 3λ/4 n, etc. However, lower values of t have the advantage of providing the desired effect over a broader range of wavelengths and with broader manufacturing tolerances on the layer thickness. Hence, thinner layers of the encapsulation layer 24 are preferred. In every case, the wavelength of light in vacuum must be divided by the refractive index of the encapsulating layer 24 to account for the speed of emitted light through the medium. It is noted that where the encapsulating layer comprises multiple component layers, the value of n used will be the effective refractive index of the total thickness of the encapsulating layers. To minimize internal reflectance in the encapsulating layer, it also preferred that the individual refractive indices of any component layer materials be as closely matched as possible.

In operation, a voltage differential is supplied to the electrodes 12 and 16 in the OLED device. The first electrode 12 may be reflective and the partially transparent second electrode 16 may also be partially reflective, thereby inducing light to waveguide in the organic layers 14. Current flows through the organic layers 14 and light is emitted in every direction from the organic layers 14. For the embodiments in which the optional scattering layer 22 is present, emitted light 1 in FIG. 1 does not waveguide along the organic layers or through the partially reflective and partially transparent second electrode 16 but is, instead, scattered through the partially reflective and partially transparent second electrode 16 after one or more encounters with the scattering layer 22. Because the partially transparent second electrode 16 is partially reflective in such embodiment, it will also reflect some light back into the organic layers 14. The reflection of light between the first electrode 12 and partially reflective and partially transparent second electrode 16 will, in the absence of the scattering layer 22, create a microcavity, the frequency of whose emitted light would have an angular dependence and whose light can effectively pass through a partially reflective electrode. However, in the presence of the scattering layer 22, any such angular dependence will tend to be destroyed. The presence of the absorption reduction layer 24 reduces the electrical field in the partially transparent second electrode 16 and reduces the absorptivity of the electrode, increasing the amount of light that is output from the OLED device. Hence, the embodiments of the present invention that contain a scattering layer combine an enhanced light output and little or no angular dependence on the frequency of light emission due to the scattering layer, and increased conductivity and transparency of the partially transparent electrode without requiring the use of additional patterned conductors.

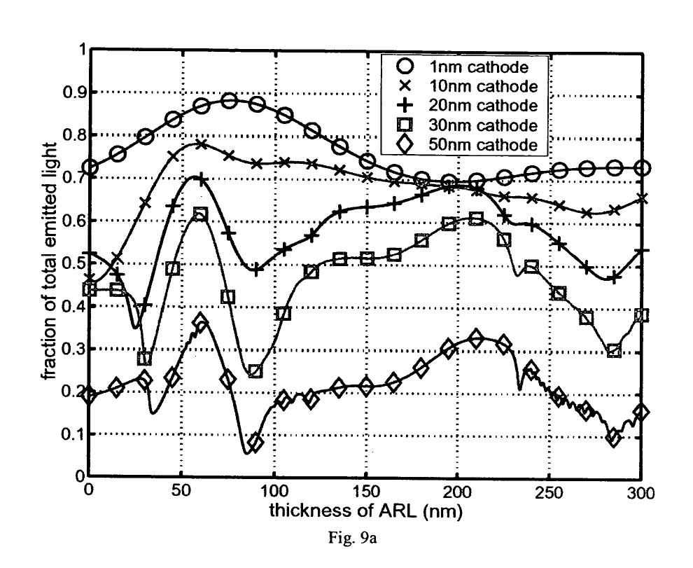

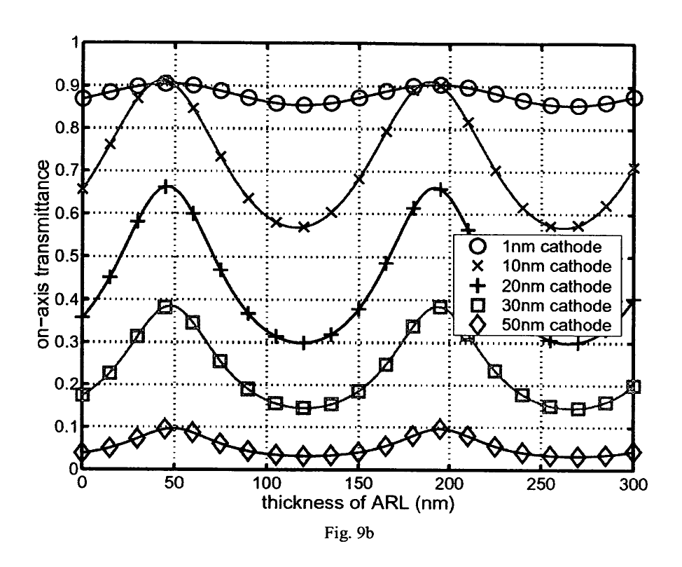

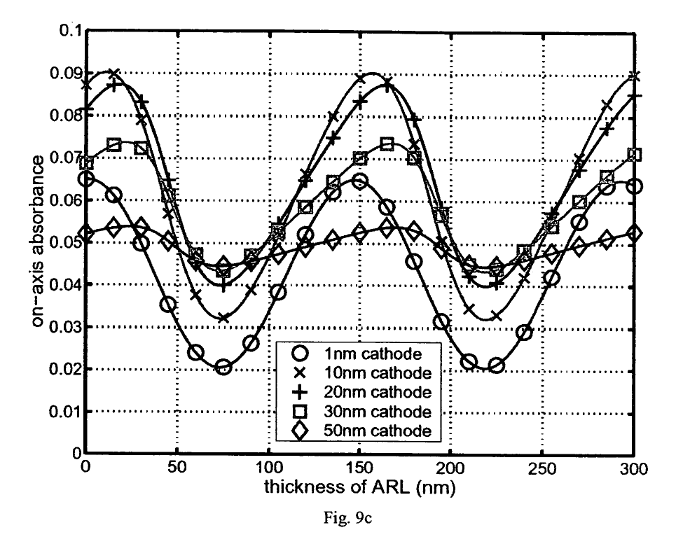

FIG. 9a is a graph of the expected fraction of light (at 525 nm wavelength) that is emitted from a device with the basic structure shown in FIG. 1, as a function of the thickness of an encapsulating absorption-reduction layer (ARL) 24, for various thicknesses of a silver partially reflective and partially transparent electrode 16. Referring to FIG. 9b, the on-axis transmittance of the partially transparent second electrode 16 together with the encapsulating ARL layer 24 is illustrated while FIG. 9c illustrates the on-axis absorption of the partially transparent second electrode 16 together with the encapsulating ARL layer 24. As can be seen from these graphs, a carefully chosen thickness of an encapsulating layer in combination with a partially transparent electrode can significantly improve the transmittance of the combination over the transmittance of the partially transparent electrode by itself. Likewise, the absorption of the combination may be reduced as compared to the absorption of the partially transparent electrode by itself.

In the optical modeling used to produce FIGS. 9a, 9b, and 9c, we have assumed that the scattering layer 22 and underlying reflective layer 15 result in 100% of the light being scattered back with a Lambertian distribution in the organic layers 14 and that air lies directly above absorption-reduction encapsulating layer 24. The organic layers 14, electrically-conductive layer 13, and the encapsulating layer 24 are all assumed to have a refractive index n=1.8, while the real and imaginary parts of the refractive index for the silver partially-reflective and partially transparent electrode 16 have been measured by spectroscopic ellipsometry and then approximately corrected for the effect of the decrease in electron scattering length introduced by the finite thickness of the metal film [U. Kreibig, Zeitschrift für Physic B 31, 39-47 (1978); R. Ruppin and H. Yatom, Physica Status Solidi (b) 74, 647-654 (1976)]. The effects of a small amount of light absorption within the various layers 13, 14, and 24 of the device or absorption by the scattering layer 22 or reflective layer 15 have also been investigated within the model and do result in further reductions in the light output of the device that can, nonetheless, be minimized through the judicious choice of materials and layer thicknesses.

The preferred thickness of the absorption-reduction encapsulating layer 24 is highly dependent on the materials used and the thickness of other layers, in particular the thickness of the partially transparent electrode. For smaller applications or those requiring lower brightness (and current density), a thinner semi-transparent electrode may be employed, for example 5 nm or 10 nm of silver, further improving transparency. For those applications requiring additional electrode conductivity, for example very large panels of OLED devices, a thicker electrode (e.g. 40 nm of silver) may be employed or the present invention may be combined with electrode strapping or electrode busses, as referenced above. The presence of reflections from other layers in the OLED will also influence the optimal selection of materials and layer thicknesses.

Applicants have demonstrated that encapsulating layers deposited by ALD, while typically more effective at encapsulation than layers coated by other techniques at equivalent thicknesses, may still result in pinholes that allow the ingress of moisture through the associated electrode and into the organic layers, thereby reducing the efficiency of the OLED device. To reduce the likelihood of pinholes in a practical device, it can be useful to employ more or thicker layers of encapsulating materials. Hence, it may be preferred to employ an encapsulating layer thickness having a value of t greater than one, for example three. Applicants have demonstrated that, in practice, OLED devices having an ALD-deposited encapsulation layer of less than about 150 nm may be inadequate to ensure long device life times. As shown in FIG. 9a, the fraction of emitted light from an OLED device having a structure similar to that shown in FIG. 1 may reach a maximum at several different absorption-reduction encapsulating layer thicknesses, at least one of which is greater than 150 nm. Likewise, as shown in FIG. 9b for a metal or metal alloy electrode (in this case, silver), the transmittance of the electrode can be enhanced by employing an absorption-reduction encapsulating layer having several different thicknesses, for example as shown with approximately 45-50 nm and at about 180-200 nm. Similarly, as shown in FIG. 9c for the same electrode, the absorption of the electrode can be minimized by employing an absorption-reduction encapsulating layer having several different thicknesses, for example as shown with approximately 75 nm and at about 220-240 nm. Hence, as shown in these Figures, the OLED device of the present invention may have an improved light output for an encapsulating layer having a thickness of at least about 100 nm, and in particular from about 180-240 nm. Light-output performance may decrease again with encapsulating layers of a thickness between 270 nm to 300 nm, after which the light output performance improves again.

It is not always necessary to construct an absorption-reducing encapsulation layer using only materials deposited by atomic layer deposition or only in a layer of one kind of materials. For example, the encapsulating layer may be formed by depositing alternating layers of an organic material such as a polymer and an inorganic material such as a ceramic. In one preferred embodiment of the present invention, one or more of the encapsulating layer(s) may be electrically conductive and include materials such as indium tin oxide or a conductive polymer material such as polythiophene. Other useful materials includes parylene and silicon dioxide.

The coating means employed to deposit inorganic materials may include atomic layer deposition. Organic materials may be deposited by other conventional coating techniques. Alternatively, two different inorganic material layers may be employed and deposited by different means, for example such as aluminum oxide deposited by ALD, and silicon dioxide, deposited by sputtering. The advantage of using different techniques and materials is that some deposition techniques may be faster than others, although the faster techniques tend to provide inferior encapsulation. By combining slow deposition layers of superior encapsulation with faster techniques having inferior encapsulation, a manufacturing process may be optimized with device encapsulation quality.

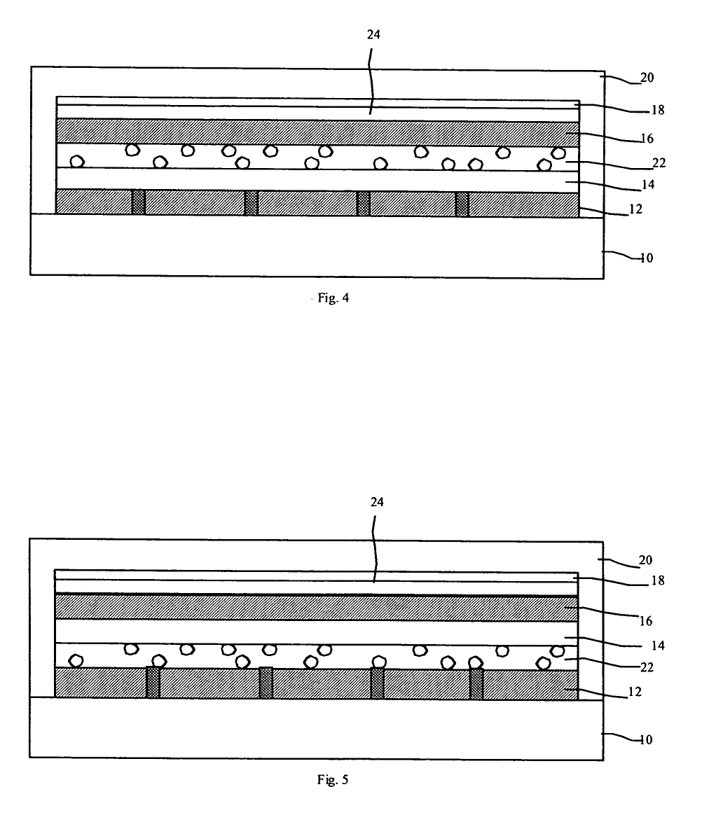

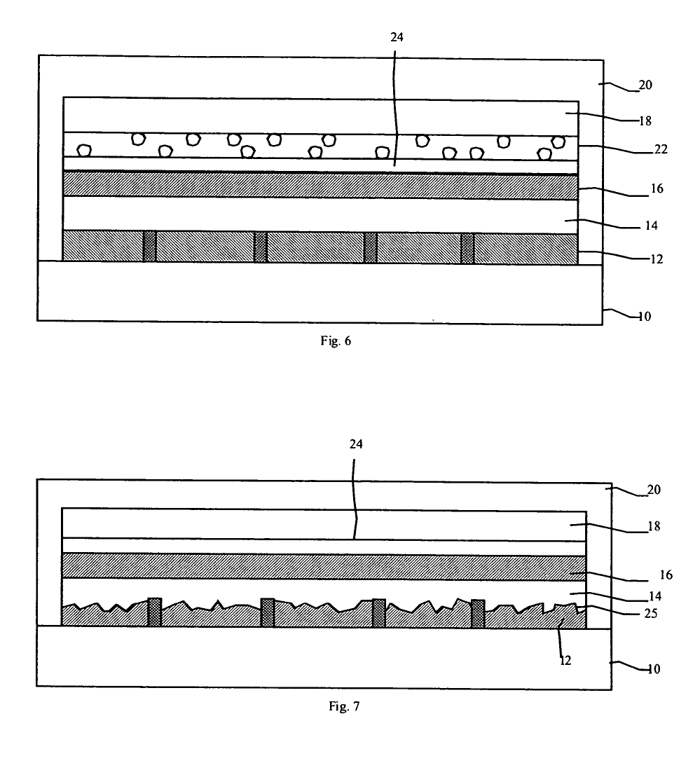

In various embodiments the scattering layer 22 when employed may be adjacent to an electrode, or is an electrode or part of an electrode as illustrated in FIGS. 1, 4, 5, 7, and 8. In yet another embodiment, illustrated in FIG. 6, the scattering layer 22 may be located adjacent to the encapsulation layer opposite the second electrode 16, either as scattering elements within a matrix (as shown), or as individual particles deposited on the surface of the encapsulating layer 24 (not shown). In a further top-emitter alternative shown in FIG. 7, scattering layer 22 may comprise a rough, diffusely reflecting surface 25 of electrode 12 itself.

Scattering layer 22 may comprise a volume scattering layer or a surface scattering layer. In certain embodiments, e.g., scattering layer 22 may comprise materials having at least two different refractive indices. The scattering layer 22 may comprise, e.g., a matrix of lower refractive index and scattering elements having a higher refractive index. Alternatively, the matrix may have a higher refractive index and the scattering elements may have a lower refractive index. For example, the matrix may comprise silicon dioxide or cross-linked resin having indices of approximately 1.5, or silicon nitride with a much higher index of refraction. If scattering layer 22 has a thickness greater than approximately one-tenth the wavelength of the emitted light, then it is desirable for the index of refraction of at least one material in the scattering layer 22 to be approximately equal to or greater than the refractive indices of the organic layers 14, the partially transparent second electrode 16, and the encapsulating layer 24.

This is to insure that all of the light trapped in the organic layers 14 and partially transparent second electrode 16 can experience the direction altering effects of scattering layer 22. If scattering layer 22 has a thickness less than approximately one-tenth the wavelength of the emitted light, then the materials in the scattering layer need not have such a preference for their refractive indices.

The scattering layer 22 is typically adjacent to and in contact with, or close to, an electrode to defeat total internal reflection in the organic layers 14 and partially transparent second electrode 16. However, if the scattering layer 22 is between the electrodes 12 and 16, it may not be necessary for the scattering layer to be in contact with an electrode 12 or 16 so long as it does not unduly disturb the generation of light in the organic layers 14. According to an embodiment of the present invention, light emitted from the organic layers 14 can waveguide along the organic layers 14 and partially transparent second electrode 16 combined. The scattering layer 22 or surface 25 disrupts the total internal reflection of light in the combined layers 14 and 16 and redirects some portion of the light out of the combined layers 14 and 16.

It is important to note that a scattering layer will also scatter light that would have been emitted out of the device back into the layers 14, exactly the opposite of the desired effect. Hence, the use of layers in the device that are as thin and transparent as possible is desired in order to minimize the absorption of the light that can undergo multiple reflections before escaping from the device.

The scattering layer 22 can employ a variety of materials. For example, randomly located spheres or particles of titanium dioxide may be employed in a matrix of polymeric material. Alternatively, a more structured arrangement employing ITO, silicon oxides, or silicon nitrides may be used. In a further embodiment, the refractive materials may be incorporated into the electrode itself so that the electrode is a scattering layer. Shapes of refractive elements may be cylindrical, rectangular, spherical, or irregular, but it is understood that the shape is not limited thereto. The difference in refractive indices between materials in the scattering layer 22 may be, for example, from 0.3 to 3, and a large difference is generally desired. The thickness of the scattering layer, or size of features in, or on the surface of, a scattering layer may be, for example, 0.03 to 50 μm. It is generally preferred to avoid diffractive effects by the scattering layer. Such effects may be avoided, for example, by locating features randomly or by ensuring that the sizes or distribution of the refractive elements are not the same as the wavelength of the color of light emitted by the device from the light-emitting area.

The scattering layer 22 should be selected to remove the light from the OLED device as quickly as possible so as to reduce the opportunities for re-absorption by the various layers of the OLED device. If the scattering layer 22 is to be located between the organic layers 14 and the transparent low-index element 18, or between the organic layers 14 and a partially reflective and partially transparent second electrode 16, then the total diffuse transmittance of the same layer coated on a glass support should be high (preferably greater than 80%). In other embodiments, where the scattering layer 22 is itself desired to be reflective, then the total diffuse reflectance of the same layer coated on a glass support should be high (preferably greater than 80%). In all cases, the absorption of the scattering layer should be as low as possible (preferably less than 5%, and ideally 0%).

Materials of the light scattering layer 22 can include organic materials (for example polymers or electrically conductive polymers) or inorganic materials. The organic materials may include, e.g., one or more of polythiophene, PEDOT, PET, or PEN. The inorganic materials may include, e.g., one or more of SiOₓ (x>1), SiNₓ (x>1), Si₃N₄, TiO₂, MgO, ZnO, Al₂O₃, SnO₂, In₂O₃, MgF₂, and CaF₂. The scattering layer 22 may comprise, for example, silicon oxides and silicon nitrides having a refractive index of 1.6 to 1.8 and containing particles of titanium dioxide having a refractive index of 2.3 to 3. Polymeric materials having refractive indices in the range of 1.4 to 1.6 may be employed having a dispersion of particles or other refractive elements of material with a higher refractive index, for example titanium dioxide.

Conventional lithographic means can be used to create the scattering layer using, for example, photo-resist, mask exposures, and etching as known in the art. Alternatively, coating may be employed in which a liquid, for example polymer having a dispersion of titanium dioxide, may form a scattering layer 22.

One problem that may be encountered with such scattering layers is that the electrodes may tend to fail open at sharp edges associated with the scattering elements in the layer 22. Although the scattering layer may be planarized, typically such operations do not form a perfectly smooth, defect-free surface. To reduce the possibility of shorts between the first and second electrodes 12 and 16, a short-reduction layer may be employed between the electrodes. Such a layer is a thin layer of high-resistance material (for example having a through-thickness resistance (defined as a product of the bulk resistivity and the film thickness) between 10⁻⁷ ohm-cm² to 10³ ohm-cm²). Because the short-reduction layer is very thin, device current can pass between the electrodes through the device layers but leakage current through the shorts is much reduced. Such layers are described in co-pending, commonly assigned U.S. Ser. No. 10/822,517, filed Apr. 12, 2004, the disclosure of which is incorporated herein by reference.

Whenever light crosses an interface between two layers of differing index, a portion of the light is reflected and another portion is refracted (except for the case of total internal reflection). Unwanted reflections can be reduced by the application of standard thin anti-reflection layers. Use of anti-reflection layers may be particularly useful on both sides of the encapsulating cover 20 for top emitters or on the substrate 10 for a bottom emitter. Referring to FIG. 1, an anti-reflective layer 21 is illustrated on the outside of transparent cover 20.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Such typical desiccant materials may be used in combination with the encapsulating layer of the invention to further improve device lifetimes.

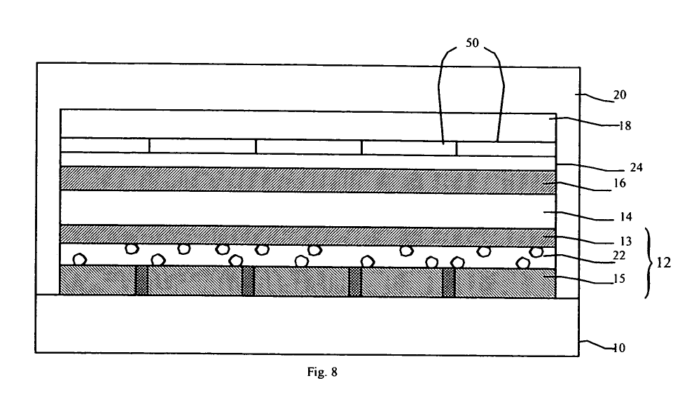

In one embodiment of the present invention, the organic layers are patterned with a variety of organic materials and produce a variety of colored light defining the colored sub-pixels of a full-color OLED device. In an alternative embodiment, the light emitted from the light-emitter layer is broadband light, for example white, and color filters may be located over the light-emitting layers 14 to provide different colors of light. Referring to FIG. 8, color filters 50 may be formed on the inside or outside of the cover or, alternatively, on the partially reflective and partially transparent second electrode 16, or encapsulating absorption-reduction layer 24.

OLED devices of this invention can employ various well-known optical effects in order to enhance their properties if desired. This includes optimizing layer thicknesses to yield maximum light transmission, providing dielectric mirror structures, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The present invention may also be practiced with either active- or passive-matrix OLED devices. It may also be employed in display devices or in area illumination devices. In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays.

The invention has been described in detail with particular reference to certain preferred embodiments thereof, but it will be understood that variations and modifications can be effected within the spirit and scope of the invention.

### Parts List

1 light rays
10 substrate
12 first electrode
13 transparent electrode layer
14 organic layer(s)
15 reflective layer
16 partially transparent second electrode
17 transparent electrode
18 transparent low-index element
19 gap
20 cover
21 anti-reflection layer
222 scattering layer
24 encapsulating layer
25 scattering reflective surface
26 dessicating material
30, 32, 34, 36, 38 pixels
40 via
41 transparent electrode bus
42 insulator
50 color filters

1. An organic light-emitting diode (OLED) device, comprising:
a) a substrate;
b) an OLED formed over the substrate comprising a first electrode, a partially transparent second electrode through which light from the OLED is emitted, and at least one layer of organic light-emitting material disposed between the first electrode and partially transparent second electrode; and
c) an encapsulating layer deposited on the partially transparent second electrode, wherein the encapsulating layer comprises one or more component layers deposited by atomic layer deposition, wherein the encapsulating layer and the partially transparent second electrode combined have a transparency greater than the transparency of the partially transparent second electrode in the absence of the encapsulating layer, or wherein the encapsulating layer and the partially transparent second electrode combined have an absorbance less than the absorbance of the partially transparent second electrode in the absence of the encapsulating layer.

2. The OLED device of claim 1 wherein the encapsulating layer has a thickness of at least 150 nm.

3. The OLED device of claim 1 wherein the partially transparent second electrode comprises a metal or metal alloy.

4. The OLED device of claim 3, wherein the partially transparent second electrode comprises silver, aluminum, or magnesium.

5. The OLED device of claim 1 wherein the partially transparent second electrode by itself has a transparency greater than 20% for light of 550 nm wavelength.

6. The OLED device of claim 1 wherein the OLED device is a top-emitter and the partially transparent second electrode is adjacent to the encapsulating layer and the first electrode is adjacent to the substrate.

7. The OLED device of claim 1, wherein the partially transparent second electrode has a thickness greater than 5 nanometers.

8. The OLED device of claim 1, wherein the partially transparent second electrode has a sheet resistance less than 3.20 ohms per square.

9. The OLED device of claim 1, wherein the encapsulating layer includes one or more materials of the group including: Zn, ZnSe, ZnS₁₋ₛSeₓ, ZnTe, CaS, SrS, BaS, SrS₁₋ₓSₓ, CdS, CdTe, MnTe, HgTe, Hg₁₋ₓCdₓTex, Cd₁₋ₓMnₓTe, AlN, GaN, InN, SiNₓ, Ta₃N₅, TiN, TiSiN, TaN, NbN, MoN, W₂N, Al₂O₃, TiO₂, ZrO₂, HfO₂, Ta₂O₅, Nb₂O₅, Y₂O₃, MgO, CeO₂, SiO₂, La₂O, SrTiO₃, BaTiO₃, BiₓTi_{y}, O_{z}, Indium Tin Oxide, Indium Oxide, SnO₂, NiO, CO₃O₄, MnOₓ, LaCoO₃, LaNiO₃, LaMnO3, CaF₂, SrF₂, ZnF₂, Si, Ge, Cu, Mo, Ta, W, La₂S₃, PbS, In₂S₃, CuGaS₂, and SiC where x, y and z are positive integers.

10. The OLED device of claim 1, wherein the encapsulating layer is formed by depositing multiple component layers of different materials.

11. The OLED device of claim 1, wherein the encapsulating layer comprises component layers of an organic material and of an inorganic material.

12. The OLED device of claim 1, wherein the encapsulating layer comprises component layers of a polymer and of a ceramic material.

13. The OLED device of claim 1, wherein the encapsulating layer is electrically conductive.

14. The OLED device of claim 1, wherein the encapsulating layer has a thickness of (tλ/4 n) where t is a positive odd integer, n is the effective refractive index of the encapsulating layer, and λ is the wavelength of any emitted light.

15. The OLED device of claim 14, wherein the encapsulating layer has a thickness of one quarter of the wavelength of any emitted light divided by the effective refractive index of the encapsulating layer.

16. The OLED device of claim 14, wherein the encapsulating layer has a thickness of three quarters of the wavelength of any emitted light divided by the effective refractive index of the encapsulating layer.

17. The OLED device of claim 1, further comprising a light scattering layer located between the substrate and the partially transparent second electrode for scattering light emitted by the light-emitting layer.

18. The OLED device of claim 17, wherein the scattering layer is adjacent to an electrode, or is an electrode or part of an electrode.

19. The OLED device of claim 17, wherein the first electrode comprises multiple layers including a transparent layer and a reflective layer and wherein the light scattering layer is located between the transparent layer and the reflective layer or wherein the scattering layer is the reflective layer.

20. The OLED device of claim 17, further comprising a cover and a transparent low-index element adjacent to the encapsulation layer opposite the partially transparent second electrode, the low-index element being positioned between the cover and the encapsulating layer and having a refractive index lower than the refractive index of the cover, the encapsulating layer, and the layers of organic light-emitting material.

21. The OLED device of claim 20, wherein the low-index element comprises an inert gas, air, nitrogen, or argon.

22. The OLED device of claim 1, wherein the encapsulating layer includes at least one inorganic layer deposited by atomic layer deposition and at least one additional layer not deposited by atomic layer deposition.

23. The OLED device of claim 22, wherein the additional layer is a polymer.

24. The OLED device of claim 22, wherein the additional layer comprises parylene or SiO₂.

25. An organic light-emitting diode (OLED) device, comprising:
a) a substrate;
b) an OLED formed over the substrate comprising a first electrode, a partially transparent second electrode through which light from the OLED is emitted, and at least one layer of organic light-emitting material disposed between the first electrode and partially transparent second electrode; and
c) an encapsulating layer deposited on the partially transparent second electrode, wherein the encapsulating layer comprises one or more component layers having a total thickness of at least 150 nm, and wherein the encapsulating layer and the partially transparent second electrode combined have a transparency greater than the transparency of the partially transparent second electrode in the absence of the encapsulating layer, or wherein the encapsulating layer and the partially transparent second electrode combined have an absorbance less than the absorbance of the partially transparent second electrode in the absence of the encapsulating layer.
